(19) United States
(12) Patent Application Publication
(10) Pub. No.: US 2026/0122255 A1
(43) Pub. Date: Apr. 30, 2026

(54) METHOD AND APPARATUS FOR ENCODING/DECODING ONE-DIMENSIONAL WAVEFORM DATA

(71) Applicant: Electronics and Telecommunications Research Institute, Daejeon (KR)

(72) Inventors: Byeong Ho CHO, Daejeon (KR); Soo Young PARK, Daejeon (KR); Jong Mo SUNG, Daejeon (KR); Seung Kwon BAECK, Daejeon (KR); Jung Won KANG, Daejeon (KR); Woo Taek LIM, Daejeon (KR); In Seon JANG, Daejeon (KR)

(73) Assignee: Electronics and Telecommunications Research Institute, Daejeon (KR)

(21) Appl. No.: 19/374,396

(22) Filed: Oct. 30, 2025

(30) Foreign Application Priority Data
Oct. 30, 2024 (KR) 10-2024-0151194
Jul. 31, 2025 (KR) 10-2025-0105426

(51) Int. Cl. H04N 19/176; H04N 19/124; H04N 19/13

(52) U.S. Cl. CPC H04N 19/176; H04N 19/124; H04N 19/13

(57) ABSTRACT

A method for decoding one-dimensional waveform data according to a present disclosure, the method comprises: decoding index information obtained by applying selective subblock scaling-based encoding to identify a subblock among one or more subblocks; performing inverse scaling by applying a scaling factor to the identified subblock; and reconstructing a current block based on a result of the inverse scaling, wherein the identified subblock is determined based on having the largest value of a predetermined indicator among the one or more subblocks.

### CROSS-REFERENCE TO RELATED APPLICATIONS

This application claims the benefit of Korean Patent Application No. 10-2024-0151194, filed on Oct. 30, 2024, and Korean Patent Application No. 10-2025-0105426, filed on Jul. 31, 2025, the contents of which are all hereby incorporated by reference herein in their entirety.

### TECHNICAL FIELD

The present disclosure relates to a method for encoding/decoding one-dimensional waveform data and an apparatus for performing the same. More specifically, the present disclosure relates to a method for encoding/decoding one-dimensional waveform data based on Selective Subblock Scaling (SSS) and an apparatus for performing the same.

### BACKGROUND

A one-dimensional waveform may be defined as a signal representing a single physical quantity that changes over time. One-dimensional waveform data possesses the characteristic of continuously changing over time. In many cases, such as bio signals (e.g., electrocardiograms, brain waves), voice, and music data, information must be preserved over time.

Since these continuous signals contain important information in specific frequency ranges, compression techniques that simultaneously consider both frequency characteristics and temporal information (e.g., compression based on the Discrete Cosine Transform (DCT) or Discrete Wavelet Transform (DWT)) may be advantageous. Accordingly, various research is being conducted to efficiently compress signals by accurately reflecting their structural characteristics, removing unnecessary data and retaining only essential information.

### SUMMARY

An object of the present disclosure is to provide a method and apparatus for encoding and/or decoding one-dimensional waveform data based on selective subblock scaling.

It is a further object of the present disclosure to provide a method for applying selective subblock scaling to an original signal.

It is a further object of the present disclosure to provide a method for applying selective subblock scaling to a residual signal.

It is a further object of the present disclosure to provide a method for applying selective subblock scaling to a transformed residual signal.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for decoding one-dimensional waveform data, the method comprising: decoding index information obtained by applying selective subblock scaling-based encoding to identify a subblock among one or more subblocks; performing inverse scaling by applying a scaling factor to the identified subblock; and reconstructing a current block based on a result of the inverse scaling, wherein the identified subblock is determined based on having the largest value of a predetermined indicator among the one or more subblocks.

In the method for decoding one-dimensional waveform data according to the present disclosure, the inverse scaling is performed on the subblock identified among one or more subblocks, the one or more subblocks are obtained from a residual block for the current block.

In the method for decoding one-dimensional waveform data according to the present disclosure, the inverse scaling is performed on the subblock identified among one or more subblocks, the one or more subblocks are obtained from inverse-quantized transform coefficients for the current block.

In the method for decoding one-dimensional waveform data according to the present disclosure, the inverse scaling is performed on the subblock identified among one or more subblocks, the one or more subblocks are obtained from a first reconstructed block, and the first reconstructed block is generated based on a prediction block of the current block and a residual block for the current block.

In the method for decoding one-dimensional waveform data according to the present disclosure, the predetermined indicator is calculated based on either a signal-independent method or a signal-dependent method, the signal-independent method includes at least one of an L2-norm, an L1-norm, and an Lp-norm, and the signal-dependent method includes at least one of a PRD, CPRD, PSNR, and a RD-loss.

In the method for decoding one-dimensional waveform data according to the present disclosure, the scaling factor is determined as a pre-defined value identically in an encoding apparatus and a decoding apparatus.

In the method for decoding one-dimensional waveform data according to the present disclosure, the scaling factor is determined as a factor among a plurality of scaling factors, and index information for specifying the factor is signaled.

In the method for decoding one-dimensional waveform data according to the present disclosure, the scaling factor is determined based on at least one of characteristics of data for which scaling is performed and a signal availability range.

In the method for decoding one-dimensional waveform data according to the present disclosure, whether to perform inverse scaling on the identified subblock is determined based on flag information indicating whether to perform the inverse scaling, and the flag information is signaled for one of a block level or a file level.

In accordance with an aspect of the present disclosure, the above and other objects can be accomplished by the provision of an apparatus for decoding one-dimensional waveform data, the scaling factor is determined, the apparatus comprising: one or more transceivers; one or more memories; and one or more processors, the one or more processors being configured to: decode index information obtained by applying selective subblock scaling-based encoding to identify a subblock among one or more subblocks; perform inverse scaling by applying a scaling factor to the identified subblock; and reconstruct a current block based on a result of the inverse scaling, wherein the identified subblock is the subblock having the largest value of a predetermined indicator that is calculated.

In accordance with an aspect of the present disclosure, the above and other objects can be accomplished by the provision for encoding one-dimensional waveform data, the method comprising: obtaining one or more subblocks having a predetermined size; calculating a predetermined indicator for each of the one or more subblocks; identifying a subblock among one or more subblocks based on the calculated predetermined indicator and encoding index information of the identified subblock; and performing scaling by applying a scaling factor to the identified subblock, wherein the identified subblock is determined based on having the largest value of a predetermined indicator among the one or more subblocks.

In the method for encoding one-dimensional waveform data according to the present disclosure, the scaling is performed on the subblock identified among one or more subblocks, and the one or more subblocks are obtained from a residual block for a current block.

In the method for encoding one-dimensional waveform data according to the present disclosure, the scaling is performed on the subblock identified among one or more subblocks, and the one or more subblocks are obtained from transform coefficients for a current block.

In the method for encoding one-dimensional waveform data according to the present disclosure, the scaling is performed on the subblock identified among one or more subblocks, and the one or more subblocks are obtained from a current block.

In the method for encoding one-dimensional waveform data according to the present disclosure, the predetermined indicator is calculated based on either a signal-independent method or a signal-dependent method, the signal-independent method includes at least one of an L2-norm, an L1-norm, and an Lp-norm, and the signal-dependent method includes at least one of a PRD, CPRD, PSNR, and a RD-loss.

In the method for encoding one-dimensional waveform data according to the present disclosure, the scaling factor is determined as a pre-defined value identically in an encoding apparatus and a decoding apparatus.

In the method for encoding one-dimensional waveform data according to the present disclosure, the scaling factor is determined as a factor among a plurality of scaling factors, and index information for specifying the factor is signaled.

In the method for encoding one-dimensional waveform data according to the present disclosure, the scaling factor is determined based on at least one of characteristics of data for which scaling is performed and a signal availability range.

In the method for encoding one-dimensional waveform data according to the present disclosure, whether to perform the scaling on the identified subblock is determined based on flag information indicating whether to perform the scaling, and the flag information is signaled for one of a block level or a file level.

In accordance with an aspect of the present disclosure, the above and other objects can be accomplished by the provision of an apparatus for encoding one-dimensional waveform data, the scaling factor is determined, the apparatus comprising: one or more transceivers; one or more memories; and one or more processors, the one or more processors being configured to: obtain one or more subblocks having a predetermined size; calculate a predetermined indicator for each of the one or more subblocks; identify a subblock among one or more subblocks based on the calculated predetermined indicator and encode index information of the identified subblock; and perform scaling by applying a scaling factor to the identified subblock, wherein the identified subblock is determined based on having the largest value of a predetermined indicator among the one or more subblocks.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

These and other features, aspects, and advantages of the present disclosure will become better understood from the following detailed description from the following detailed description taken in conjunction with the accompanying drawings, in which:

FIG. 1 is a diagram illustrating an encoding apparatus for performing a one-dimensional waveform data encoding method according to one embodiment of the present disclosure.

FIG. 2 is a diagram illustrating a decoding apparatus for performing a one-dimensional waveform data decoding method according to one embodiment of the present disclosure.

FIG. 3 is a flowchart illustrating a selective subblock scaling method according to one embodiment of the present disclosure.

FIG. 4 is a flowchart illustrating a selective subblock inverse scaling method according to one embodiment of the present disclosure.

FIG. 5 is a diagram illustrating a one-dimensional waveform data encoding method and apparatus according to one embodiment of the present disclosure.

FIG. 6 is a diagram illustrating a one-dimensional waveform data decoding method and apparatus according to one embodiment of the present disclosure.

FIG. 7 is a diagram illustrating a one-dimensional waveform data encoding method and apparatus according to one embodiment of the present disclosure.

FIG. 8 is a diagram illustrating a one-dimensional waveform data decoding method and apparatus according to one embodiment of the present disclosure.

FIG. 9 is a diagram illustrating a one-dimensional waveform data encoding method and apparatus according to one embodiment of the present disclosure.

FIG. 10 is a diagram illustrating a one-dimensional waveform data decoding method and apparatus according to one embodiment of the present disclosure.

FIG. 11 is a block diagram illustrating an apparatus according to an embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is for illustrative purposes only and is not intended to be limiting. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

This disclosure proposes a method for encoding/decoding one-dimensional waveform data based on selective subblock scaling. Specifically, a data block of a one-dimensional waveform may be partitioned into subblocks of a predetermined size, and scaling may be performed by automatically selecting a section with the highest necessity of compression through analysis of each subblock. Therefore, the method of this disclosure enables compression and reconstruction even with a small bit rate. Below, the method proposed in this disclosure will be described in detail.

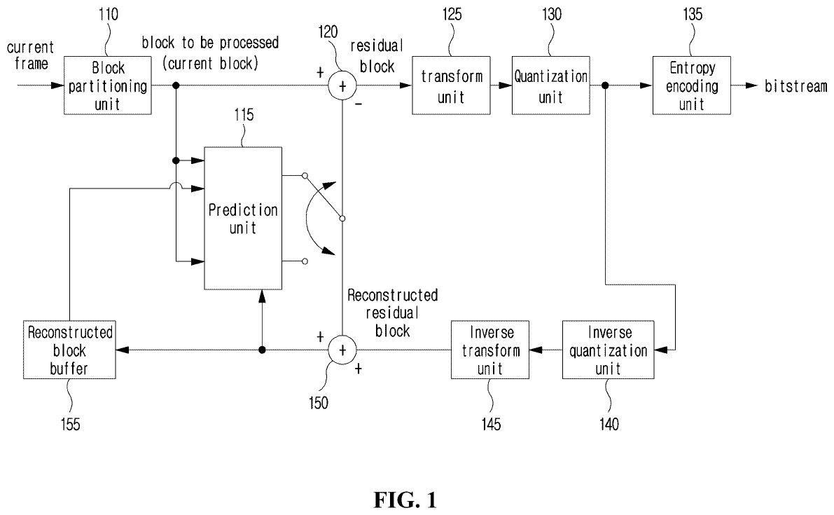

FIG. 1 is a diagram illustrating an encoding apparatus for performing a one-dimensional waveform data encoding method according to one embodiment of the present disclosure.

Referring to FIG. 1, an encoding apparatus according to the present disclosure may include at least one of a block partitioning unit 110, a prediction unit 115, a residual generation unit 120, a transform unit 125, a quantization unit 130, an entropy encoding unit 135, an inverse quantization unit 140, an inverse transform unit 145, a reconstructed block generation unit 150, and a reconstructed block buffer 155.

The block partitioning unit 110 may partition input data into one or more processing units, wherein the input data may be one-dimensional waveform data, and the one or more processing units may also be understood as an original block or an original signal.

In this case, the processing unit may be a prediction unit (PU), a transform unit (TU), or a coding unit (CU). Hereinafter, in embodiments of the present disclosure, the coding unit may be used to refer to a unit that performs encoding or a unit that performs decoding, and the coding unit to be processed may be referred to as a current block.

The prediction unit 115 may include an inter prediction unit that performs inter prediction, an intra prediction unit that performs intra prediction, and a coding mode determination unit. The coding mode determination unit may determine whether a coding mode of a prediction unit is inter prediction or intra prediction.

Additionally, prediction mode information, motion vector information, etc. used for prediction may be encoded together with a residual value in the entropy encoding unit 135 and transmitted to the decoding apparatus.

The inter prediction unit may predict a prediction unit based on information from at least one of previous frames and subsequent frames of a current frame, and in some cases, may predict the prediction unit based on information from a portion of the encoded region within the current frame.

The intra prediction unit may generate a prediction unit based on reference sample information neighboring the current block, which is sample information within the current frame. When a neighboring block of the current prediction unit is a block that performed inter prediction and the reference samples are samples that performed inter prediction, the reference samples included in the block that performed inter prediction may be replaced with the reference sample information of the neighboring block that performed intra prediction. That is, when reference samples are unavailable, the unavailable reference sample information may be replaced with at least one available reference sample and used.

Additionally, the residual generation unit 120 may generate a residual block including residual information, which is a difference between the prediction unit (PU) generated by the prediction unit 115 through prediction and an original block of the prediction unit (PU). The generated residual block may be input to the transform unit 125.

The transform unit 125 may selectively transform the residual block including residual information of the original block and the prediction unit (PU) generated by the prediction unit 115 using any one of the following transform methods: Discrete Cosine Transform (DCT), Discrete Sine Transform (DST), or Discrete Wavelet Transform (DWT).

The quantization unit 130 may quantize the coefficients converted to the frequency domain by the transform unit 125. The quantized coefficients may vary depending on a block or depending on importance of data. A value generated in the quantization unit 130 may be provided to the inverse quantization unit 140. The value generated in the quantization unit 130 may also be provided to a reordering unit.

The reordering unit may perform reordering of coefficient values for quantized residual values. The reordering unit may change two-dimensional block-form coefficients into a one-dimensional vector form through a coefficient scanning method. For example, the reordering unit may use a zig-zag scan method to scan from DC coefficients to coefficients in a high-frequency region and change them into a one-dimensional vector form. Depending on the size of a transform unit (TU) and an intra prediction mode, a vertical scan that scans two-dimensional block-form coefficients in a column direction or a horizontal scan that scans two-dimensional block-form coefficients in a row direction may be used. That is, the reordering unit may determine which of a zig-zag scan, a vertical scan, or a horizontal scan is to be used depending on the size of the transform unit (TU) and the intra prediction mode.

The entropy encoding unit 135 may perform entropy encoding based on values generated by the quantization unit or the reordering unit. The entropy encoding may use various encoding methods such as Exponential Golomb, Context-Adaptive Variable Length Coding (CAVLC), or Context-Adaptive Binary Arithmetic Coding (CABAC). The entropy encoding unit 135 may encode various information including residual coefficient information of a coding unit, block type information, prediction mode information, partitioning unit information, prediction unit information, transmission unit information, motion vector information, reference frame information, interpolation information of a block, quantization coefficient information, and filtering information.

The inverse quantization unit 140 and the inverse transform unit 145 may inversely quantize the values quantized in the quantization unit 130 and inversely transform the transformed coefficients in the transform unit 125.

The reconstructed block generation unit 150 may generate a reconstructed block by adding the residual values generated by the inverse quantization unit 140 and the inverse transform unit 145 to the prediction unit (PU) predicted by the prediction unit 115.

The encoding apparatus may further include an in-loop filter unit. The in-loop filter unit may include at least one of a deblocking filter, an offset compensation unit, and an adaptive loop filter (ALF). The deblocking filter may remove block distortion cased by block boundaries in a reconstructed frame. The offset compensation unit may compensate, on a sample basis, an offset from an original signal for a signal on which deblocking is performed. To perform offset compensation for a specific frame, a method of dividing samples included in the signal into a predetermined number of regions, determining a region to which an offset is applied, and applying the offset to the determined region, or a method of applying the offset by considering edge information of each sample may be used. The adaptive loop filter (ALF) may be performed based on a value obtained by comparing a filtered reconstructed signal with an original signal. Samples included in the signal may be divided into predetermined groups, and one filter to be applied to the group may be determined so that filtering is performed differently for each group.

The reconstructed block buffer 155 may store the generated reconstructed blocks or frames, and the stored reconstructed block or frame may be provided to the prediction unit 115 when performing inter prediction.

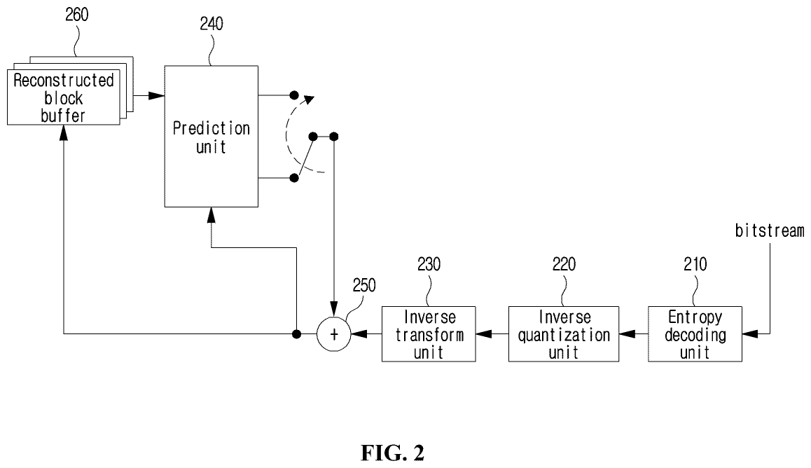

FIG. 2 is a diagram illustrating a decoding apparatus for performing a one-dimensional waveform data decoding method according to one embodiment of the present disclosure.

Referring to FIG. 2, a decoding apparatus according to the present disclosure may include an entropy decoding unit 210, an inverse quantization unit 220, an inverse transform unit 230, a prediction unit 240, a reconstructed block generation unit 250, and a reconstructed block buffer 260.

When a bitstream is input to an encoding apparatus, the input bitstream may be decoded using the reverse process of the encoding apparatus.

The entropy decoding unit 210 may perform entropy decoding through a procedure opposite to entropy encoding performed in the entropy encoding unit of the encoding apparatus. For example, various methods such as Exponential Golomb, Context-Adaptive Variable Length Coding (CAVLC), or Context-Adaptive Binary Arithmetic Coding (CABAC) may be used.

The entropy decoding unit 210 may decode various information transmitted from the encoding apparatus, including residual coefficient information, block type information, prediction mode information, partitioning unit information, prediction unit information, transmission unit information, motion vector information, reference frame information, interpolation information of a block, quantization coefficient information, and filtering information.

The quantized values may be inverse quantized in the inverse quantization unit 220, and the inverse transform unit 230 may perform an inverse transform i.e., an inverse DCT, an inverse DST, or an inverse DWT, on the quantization result generated in the encoding apparatus, with respect to the transform such as a DCT, a DST, or a DWT that is performed in the transform unit 125. The inverse transform may be performed based on a transmission unit determined in the encoding apparatus. In the inverse transform unit 230 of the decoding apparatus, a transform technique (for example, DCT, DST, or DWT) may be selectively performed depending on various information such as a prediction method, a size of a current block, and a prediction direction.

The prediction unit 240 may generate a prediction block based on prediction block generation-related information provided from the entropy decoding unit 210 and previously decoded block or frame information from the reconstructed block buffer 260.

The prediction unit 240 may include a coding mode determination unit, an intra prediction unit, and an inter prediction unit. The coding mode determination unit may receive various information including prediction unit information input from the entropy decoding unit 210, prediction mode information of an intra prediction method, or motion prediction-related information of an inter prediction method, and may determine whether a current block performs inter prediction or intra prediction.

On the other hand, if the encoding apparatus does not transmit motion prediction-related information for the inter prediction, but instead transmits information indicating that the motion information is to be derived and used by the decoding apparatus and information about the technique used to derive the motion information, the prediction unit determination unit may determine, based on the information transmitted from the encoding apparatus, whether prediction is to be performed by the inter prediction unit.

The intra prediction unit may generate a prediction block based on sample information within the current frame. When a prediction unit performs intra prediction, the intra prediction unit may perform intra prediction based on intra prediction mode information of the prediction unit provided from the encoding apparatus.

The inter prediction unit may perform inter prediction on the current prediction unit based on information included in at least one of the previous frames and the subsequent frames of the current frame, using information necessary for inter prediction of the current prediction unit provided from the encoding apparatus.

The reconstructed block or frame may be provided to an in-loop filter unit. The in-loop filter unit may include a deblocking filter, an offset compensation unit, and an ALF.

The reconstructed block generation unit 250 may generate a reconstructed block by adding the residual values generated by the inverse quantization unit 220 and the inverse transform unit 230 to the prediction unit (PU) predicted by the prediction unit 240.

The reconstructed block buffer 260 may store reconstructed frames or blocks so that they may be used as reference frames or reference blocks, and may also provide reconstructed frames to the output unit.

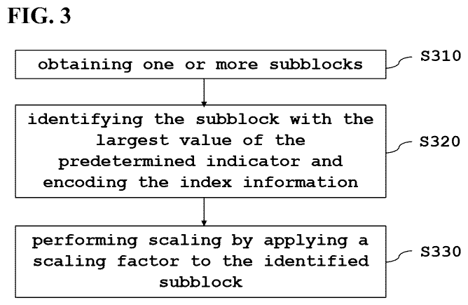

FIG. 3 is a flowchart illustrating a selective subblock scaling method according to one embodiment of the present disclosure.

Referring to FIG. 3, one or more subblocks having a predetermined size may be obtained S310.

According to one embodiment of the present disclosure, input data may be partitioned to obtain subblocks having a predetermined size.

The input data may be any of the original signal, the residual signal after prediction, or a signal resulting from the transformed residual signal, as described below.

According to one embodiment of the present disclosure, the length of a subblock may be adaptively determined based on the characteristics of the input data. The input data may be any of the following: an original signal, a residual signal, residual signal after prediction, or a signal resulting from the transformed residual signal.

According to one embodiment of the present disclosure, the length of a subblock may be determined to be the same for each subblock or may be determined differently. That is, the length of a subblock may be determined to be uniform or non-uniform.

According to one embodiment of the present disclosure, information related to a subblock may be shared between an encoding apparatus and a decoding apparatus. That is, information related to a subblock may be commonly referenced by the encoding apparatus and the decoding apparatus.

Referring to FIG. 3, a predetermined indicator for each of the one or more subblocks is calculated S320.

According to one embodiment of the present disclosure, a predetermined indicator may be calculated using either a signal-independent method or a signal-dependent method. According to one embodiment of the present disclosure, the predetermined indicator used may be flexibly determined during the design process of the encoding apparatus and/or decoding apparatus.

The signal-independent method may include at least one of the L2-norm, L1-norm, and Lp-norm.

The L2 norm may be calculated as the square root of the sum of the squares of respective components of a vector. For example, it may be calculated using the following mathematical equation 1.

$${‖ x ‖}_{2} = \sqrt{{\sum }_{i = 1}^{n} {x}_{i}^{2}} \qquad [ Mathematical equation 1 ]$$

Here, ∥x∥₂ represents the L2-norm, and n represents the dimensionality of the vector.

The L1 norm may be calculated as the sum of the absolute values of respective components of a vector. For example, it may be calculated using the following mathematical equation 2.

$${‖ x ‖}_{1} = {\sum }_{i = 1}^{n} \vert {x}_{i} \vert \qquad [ Mathematical equation 2 ]$$

Here, ∥x∥₁ represents the L1-norm, and n represents the dimensionality of the vectors.

The Lp-norm may be calculated as the sum of the absolute values of respective components of a vector. For example, it may be calculated the following mathematical equation 3.

$${‖ x ‖}_{p} = {( {\sum }_{i = 1}^{n} {\vert {x}_{i} \vert}^{p} )}^{1 / p} \qquad [ Mathematical equation 3 ]$$

Here, |x∥ₚ represents the Lp-norm, and n represents the dimensionality of the vectors. Here, p may be a real number greater than 0 and less than 1 (0<p<1).

The signal-dependent method may include at least one of Percent Root-mean-square Difference (PRD), Compression Percent Root-mean-square Difference (CPRD), Peak Signal-to-Noise Ratio (PSNR), and Rate-Distortion Loss (RD-loss).

Here, PRD refers to a method that expresses the degree of loss in the reconstructed signal as a percentage, or an indicator calculated based on this method. CPRD refers to a method that modified PRD by considering compression performance, or an indicator calculated based on this method. PRD may be calculated, for example, using the following mathematical equation 4.

$$P R D = \frac{\sqrt{{\sum }_{i = 1}^{N} {( {x}_{i} - {\hat{x}}_{i} )}^{2}}}{\sqrt{{\sum }_{i = 1}^{N} {x}_{i}^{2}}} \times 100 \% \qquad [ Mathematical equation 4 ]$$

Here, xᵢ may mean the original signal, and \hat{x}ᵢ may mean the reconstructed signal.

PSNR may refer to a method that represents the ratio of the maximum signal value to the noise, or an indicator calculated based on this method. PSNR may be calculated, for example, using the following mathematical equation 5.

$$P S N R = 10 \cdot {log}_{10} ( \frac{{MAX}^{2}}{M S E} ) \qquad [ Mathematical equation 5 ]$$

Here, MAX may represent the maximum value of the signal. MSE may represent the mean square error between the original and reconstructed signals.

RD-loss may refer to a method expressed in the form of a loss function used to quantitatively evaluate compression performance, or an indicator calculated based on this method.

Referring to FIG. 3, a subblock with the largest calculated index value may be identified and the index information of the identified subblock may be encoded S330.

According to one embodiment of the present disclosure, a subblock having the largest calculated index value may be identified, and index information of the subblock may be encoded and signaled.

Referring to FIG. 3, scaling is performed by applying a scaling factor to the identified subblock S340.

According to one embodiment of the present disclosure, a data value of an identified subblock may be divided by a scaling factor. The scaling factor may also be understood as a selective subblock scaling factor (SSS_FACTOR).

According to one embodiment of the present disclosure, the scaling factor may be adaptively determined by considering at least one of the characteristics of the input data and the signal availability range.

According to one embodiment of the present disclosure, scaling factor information may be pre-defined in the encoding and decoding apparatuses. In this case, the bit rate may be reduced by eliminating the need for additional signaling bits. Alternatively, one of at least two scaling factors may be indicated by encoding and signaling scaling factor information.

According to one embodiment of the present disclosure, selective subblock scaling may be enabled or disabled by signaling flag information indicating whether to divide the data values of a subblock using a scaling factor. For example, the flag information may be signaled at either a block-by-block or file-by-file basis.

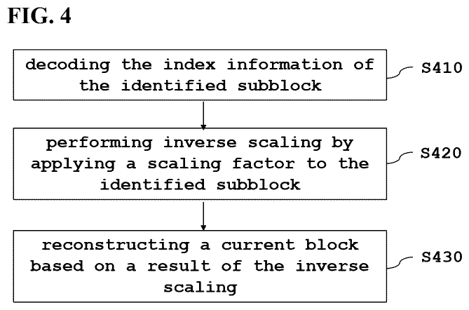

FIG. 4 is a flowchart illustrating a selective subblock inverse scaling method according to one embodiment of the present disclosure.

Referring to FIG. 4, index information of an identified subblock may be decode S410.

According to one embodiment of the present disclosure, index information for the subblock with the largest calculated indicator value may be signaled. By decoding the index information, the subblock with the largest calculated indicator value may be identified using a selective subblock scaling method.

Referring to FIG. 4, inverse scaling is performed by applying a scaling factor to the identified subblock S420.

The inverse scaling may be understood as the reverse process of selective subblock scaling.

According to one embodiment of the present disclosure, the data values of identified subblock may be multiplied by a scaling factor. This enables accurate reconstruction of data lost during the compression process.

According to one embodiment of the present disclosure, scaling factor information may be pre-defined in the encoding apparatus and decoding apparatus. In this case, the bit rate may be reduced by eliminating the need for additional signaling bits. Alternatively, one of at least two scaling factors may be indicated by encoding and signaling scaling factor information.

According to one embodiment of the present disclosure, selective subblock scaling may be enabled or disabled by signaling flag information indicating whether to divide the data values of a subblock using a scaling factor. For example, the flag information may be signaled at either a block-by-block or file-by-file basis.

Referring to FIG. 4, a current block is reconstructed based on a result of the inverse scaling S430.

The reconstruction process may vary depending on the input data being encoded.

According to one embodiment of the present disclosure, a reconstructed block may be generated by adding a residual block on which inverse scaling is performed to a prediction block.

According to one embodiment of the present disclosure, a reconstructed block may be generated by adding the inversely transformed coefficients on which inverse scaling is performed to a prediction block.

According to one embodiment of the present disclosure, a final reconstructed block of the current block (hereinafter referred to as a second reconstructed block) may be generated by performing inverse scaling on a first reconstructed block. Here, the first reconstructed block may be generated by adding a residual block to a prediction block.

Meanwhile, as previously discussed, when the input data is either a residual signal after prediction (Example 1), a signal resulting from the transformed residual signal (Example 2), or the original signal (Example 3), a selective subblock (inverse) scaling method may be applied to encode/decode one-dimensional waveform data. Below, a method for encoding/decoding one-dimensional waveform data according to this method will be described.

### Example 1

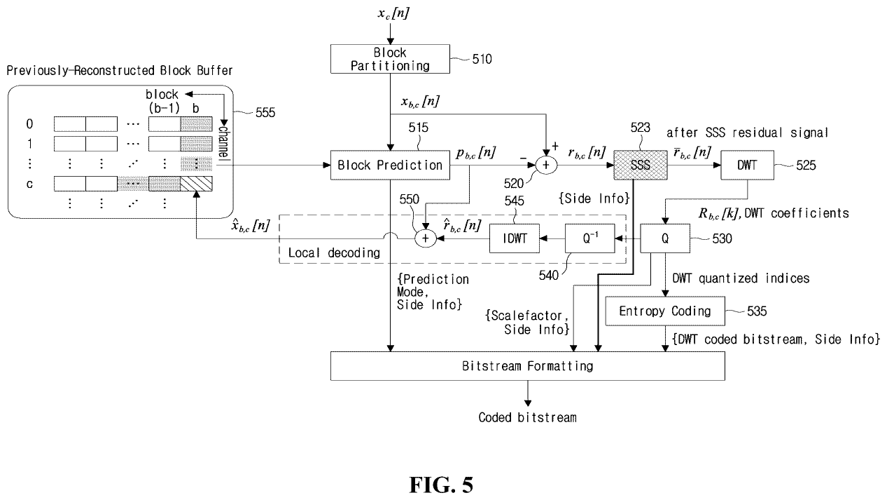

FIG. 5 is a diagram illustrating a one-dimensional waveform data encoding method and apparatus according to one embodiment of the present disclosure.

Referring to FIG. 5, the encoding apparatus according to the present disclosure may include at least one of a block partitioning unit 510, a prediction unit 515, a residual generation unit 520, a selective subblock scaling unit 523, a transform unit 525, a quantization unit 530, an entropy encoding unit 535, an inverse quantization unit 540, an inverse transform unit 545, a reconstructed block generation unit 550, and a reconstructed block buffer 555.

The block partitioning unit 510 may partition the input data into one or more processing units. That is, x_{c}[n] may be partitioned into x_{b,c}[n]. As described in detail with reference to FIG. 1, a detailed description will be omitted here to avoid redundancy.

The prediction unit 515 may include an inter prediction unit that performs inter-frame prediction and an intra prediction unit that performs intra-frame prediction.

The inter prediction unit may predict a prediction unit based on information from at least one of previous frames and subsequent frames of a current frame, and in some cases, may predict the prediction unit based on information from a portion of the encoded region within the current frame.

The intra prediction unit may generate a prediction unit based on reference sample information neighboring the current block, which is sample information within the current frame.

Additionally, the prediction mode information, motion vector information, etc. used for prediction may be encoded together with a residual value in the entropy encoding unit 535 and transmitted to the decoding apparatus. Regarding the prediction unit 515, as described in detail with reference to FIG. 1, a detailed description will be omitted here to avoid redundancy.

The residual generation unit 520 may generate a residual block (r_{b,c}[n]) that includes residual information, which is a difference between the prediction unit (PU) generated by the prediction unit 515 through prediction and an original block of the prediction unit (PU).

The selective subblock scaling unit 523 may perform selective subblock scaling on a residual block. Specifically, one or more subblocks of a predetermined size may be obtained from the residual block. A predetermined indicator may be calculated for each of the one or more subblocks. Scaling may be performed by applying a scaling factor to the identified subblock. The selective subblock scaling method has been described in detail with reference to FIG. 3, and a detailed description thereof will be omitted here.

The residual block (\hat{r}_{b,c}[n]) on which selective subblock scaling is performed may be input to the transform unit 525.

The transform unit 525 may transform the original block and the residual block (\tilde{r}_{b,c}[n]) on which selective subblock scaling is performed by selectively using one of a discrete cosine transform (DCT), discrete sine transform (DST), or discrete wavelet transform (DWT).

The quantization unit 530 may quantize the coefficients converted to the frequency domain by the transform unit 525.

The reordering unit may perform reordering of coefficient values for quantized residual values. The reordering unit may change two-dimensional block-form coefficients into a one-dimensional vector form through a coefficient scanning method. As described in detail with reference to FIG. 1, a detailed description will be omitted here.

The entropy encoding unit 535 may perform entropy encoding based on values generated by the reordering unit. The entropy encoding may use various encoding methods such as Exponential Golomb, Context-Adaptive Variable Length Coding (CAVLC), or Context-Adaptive Binary Arithmetic Coding (CABAC). The entropy encoding unit 535 may encode various information including residual coefficient information of a coding unit, block type information, prediction mode information, partitioning unit information, prediction unit information, transmission unit information, motion vector information, reference frame information, interpolation information of a block, quantization coefficient information, and filtering information.

The entropy encoding unit 535 may encode the obtained index information by applying a selective subblock scaling method. As described in detail with reference to FIG. 3, a detailed description will be omitted here.

Additionally, the entropy encoding unit 535 may signal scaling factor information or flag information, if necessary. As described in detail with reference to FIG. 3, a detailed description will be omitted here.

The inverse quantization unit 540 and the inverse transform unit 545 may inversely quantize the values (R_{b,c}[k]) quantized in the quantization unit 530 and inversely transform the coefficients transformed in the transform unit 525.

The reconstructed block generation unit 550 may generate a reconstructed block (\hat{x}_{b,c}[n]) by adding the residual values (\hat{r}_{p,c}[n]) generated by the inverse quantization unit 540 and the inverse transform unit 545 to the prediction unit (PU) (p_{b,c}[n]) predicted by the prediction unit 515.

The in-loop filter unit may include at least one of a deblocking filter, an offset compensation unit, and an adaptive loop filter (ALF). As described in detail with reference to FIG. 1, a detailed description will be omitted here.

The reconstructed block buffer 555 may store the reconstructed frames or blocks of a specific channel. Specifically, the index of a specific channel may be represented by c, where c may be an inter of 0, 1, 2, or more. The index of a frame or block may be represented by b, where b may be an integer of 0, 1, 2, or more.

The reconstructed block buffer 555 may store the generated reconstructed blocks or frames, and the stored reconstructed blocks or frames may be provided to the prediction unit 515 when performing inter prediction.

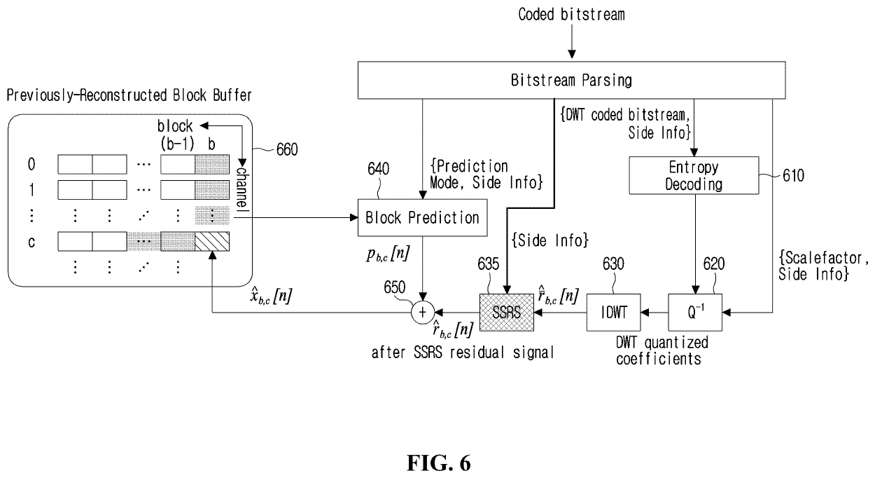

FIG. 6 is a diagram illustrating a one-dimensional waveform data decoding method and apparatus according to one embodiment of the present disclosure.

Referring to FIG. 6, the decoding apparatus according to the present disclosure may include an entropy decoding unit 610, an inverse quantization unit 620, an inverse transform unit 630, a selective subblock inverse scaling unit 635, a prediction unit 640, a reconstructed block generation unit 650, and a reconstructed block buffer 660.

The entropy decoding unit 610 may decode information related to intra prediction and inter prediction performed in the encoding apparatus.

The entropy decoding unit 610 may decode the obtained index information by applying a selective subblock scaling method. As described in detail with reference to FIG. 3, a detailed description will be omitted here.

Additionally, the entropy encoding unit 610 may signal scaling factor information or flag information, if necessary. As described in detail with reference to FIG. 3, a detailed description will be omitted here.

The quantized values may be inverse quantized in the inverse quantization unit 620, and the inverse transform unit 630 may perform an inverse transform that is, an inverse DCT, an inverse DST, or an inverse DWT, on coefficients on which selective subblock inverse scaling is performed. The inverse transform may be performed based on a transmission unit determined in the encoding apparatus. In the inverse transform unit 630 of the decoding apparatus, a transform technique (for example, DCT, DST, or DWT) may be selectively performed depending on various information such as a prediction method, a size of a current block, and a prediction direction.

The selective subblock inverse scaling unit 635 may perform selective subblock inverse scaling on inverse transformed coefficients. Specifically, index information obtained by applying selective subblock scaling-based encoding may be decoded to identify a subblock among one or more subblocks obtained from the inverse transformed coefficients, and inverse scaling may be performed by applying a scaling factor to the identified subblock. The selective subblock inverse scaling method has been described in detail with reference to FIG. 4, and a detailed description thereof will be omitted here.

The prediction unit 640 may generate a prediction block (p_{b,c}[n]) based on prediction block generation-related information provided from the entropy decoding unit 610 and previously decoded block or frame information from the reconstructed block buffer 660. As described in detail with reference to FIG. 2, a detailed description will be omitted here to avoid redundancy.

The reconstructed block generation unit 650 may generate a reconstructed block (\hat{x}_{b,c}[n]) by adding the residual values (\hat{r}_{b,c}[n]) generated by the inverse quantization unit 620, the inverse transform unit 630, and the selective subblock inverse scaling unit 635 to the prediction unit (PU) (p_{b,c}[n]) predicted by the prediction unit 640.

The reconstructed block buffer 660 may store the reconstructed frames or blocks of a specific channel. Specifically, the index of a specific channel may be represented by c, where c may be an inter of 0, 1, 2, or more. The index of a frame or block may be represented by b, where b may be an integer of 0, 1, 2, or more.

The reconstructed block buffer 660 may store reconstructed frames or blocks so that they may be used as reference frames or reference blocks, and may also provide reconstructed frames to the output unit.

### Example 2

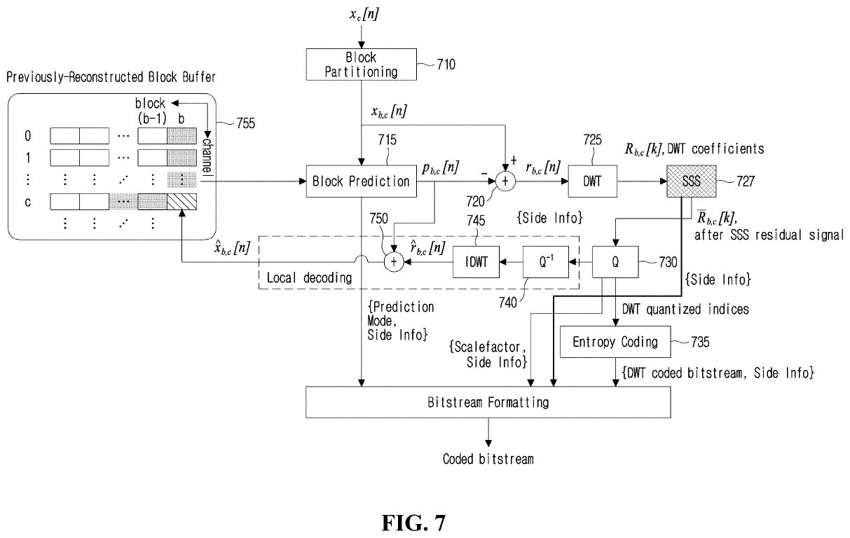

FIG. 7 is a diagram illustrating a one-dimensional waveform data encoding method and apparatus according to one embodiment of the present disclosure.

Referring to FIG. 7, the encoding apparatus according to the present disclosure may include at least one of a block partitioning unit 710, a prediction unit 715, a residual generation unit 720, a transform unit 725, a selective subblock scaling unit 727, a quantization unit 730, an entropy encoding unit 735, an inverse quantization unit 740, an inverse transform unit 745, a reconstructed block generation unit 750, and a reconstructed block buffer 755.

The block partitioning unit 710 may partition the input data into one or more processing units. That is, x_{c}[n] may be partitioned into x_{b,c}[n]. As described in detail with reference to FIG. 1, a detailed description will be omitted here to avoid redundancy.

The prediction unit 715 may include an inter prediction unit that performs inter-frame prediction and an intra prediction unit that performs intra-frame prediction.

The inter prediction unit may predict a prediction unit based on information from at least one of previous frames and subsequent frames of a current frame, and in some cases, may predict the prediction unit based on information from a portion of the encoded region within the current frame.

The intra prediction unit may generate a prediction unit based on reference sample information neighboring the current block, which is sample information within the current frame.

Additionally, the prediction mode information, motion vector information, etc. used for prediction may be encoded together with a residual value in the entropy encoding unit 735 and transmitted to the decoding apparatus. Regarding the prediction unit 715, as described in detail with reference to FIG. 1, a detailed description will be omitted here to avoid redundancy.

The residual generation unit 720 may generate a residual block (r_{b,c}[n]) that includes residual information, which is a difference between the prediction unit (PU) generated by the prediction unit 715 through prediction and an original block of the prediction unit (PU).

The transform unit 725 may transform the residual block (r_{b,c}[n]) including residual information of an original block and a prediction unit generated through the prediction unit 715 by selectively using one of a discrete cosine transform (DCT), discrete sine transform (DST), or discrete wavelet transform (DWT).

The selective subblock scaling unit 727 may perform selective subblock scaling on the transformed coefficients, i.e., the residual block (R_{b,c}[k]). Specifically, one or more subblocks of a predetermined size may be obtained from residual block on which a transform is performed. A predetermined indicator may be calculated for each of the one or more subblocks. Scaling may be performed by applying a scaling factor to the identified subblock. The selective subblock scaling method has been described in detail with reference to FIG. 3, and a detailed description thereof will be omitted here.

The transform coefficients (\tilde{R}_{b,c}[k]) on which selective subblock scaling is performed may be input to the transform unit 730.

The quantization unit 730 may quantize the coefficients converted to the frequency domain by the transform unit 725.

The reordering unit may perform reordering of coefficient values for quantized residual values. The reordering unit may change two-dimensional block-form coefficients into a one-dimensional vector form through a coefficient scanning method. As described in detail with reference to FIG. 1, a detailed description will be omitted here.

The entropy encoding unit 735 may perform entropy encoding based on values generated by the reordering unit. The entropy encoding may use various encoding methods such as Exponential Golomb, Context-Adaptive Variable Length Coding (CAVLC), or Context-Adaptive Binary Arithmetic Coding (CABAC). The entropy encoding unit 735 may encode various information including residual coefficient information of a coding unit, block type information, prediction mode information, partitioning unit information, prediction unit information, transmission unit information, motion vector information, reference frame information, interpolation information of a block, quantization coefficient information, and filtering information. The entropy encoding unit 735 may encode the obtained index information by applying a selective subblock scaling method.

The inverse quantization unit 740 and the inverse transform unit 745 may inversely quantize the values quantized in the quantization unit 730 and inversely transform the coefficients transformed in the transform unit 725.

The reconstructed block generation unit 750 may generate a reconstructed block (\hat{x}_{b,c}[n]) by adding the residual values (\hat{r}_{b,c}[n]) generated by the inverse quantization unit 740 and the inverse transform unit 745 to the prediction unit (PU) (p_{b,c}[n]) predicted by the prediction unit 715.

The in-loop filter unit may include at least one of a deblocking filter, an offset compensation unit, and an adaptive loop filter (ALF). As described in detail with reference to FIG. 1, a detailed description will be omitted here.

The reconstructed block buffer 755 may store the reconstructed frames or blocks of a specific channel. Specifically, the index of a specific channel may be represented by c, where c may be an inter of 0, 1, 2, or more. The index of a frame or block may be represented by b, where b may be an integer of 0, 1, 2, or more.

The reconstructed block buffer 755 may store the generated reconstructed blocks or frames, and the stored reconstructed blocks or frames may be provided to the prediction unit 715 when performing inter prediction.

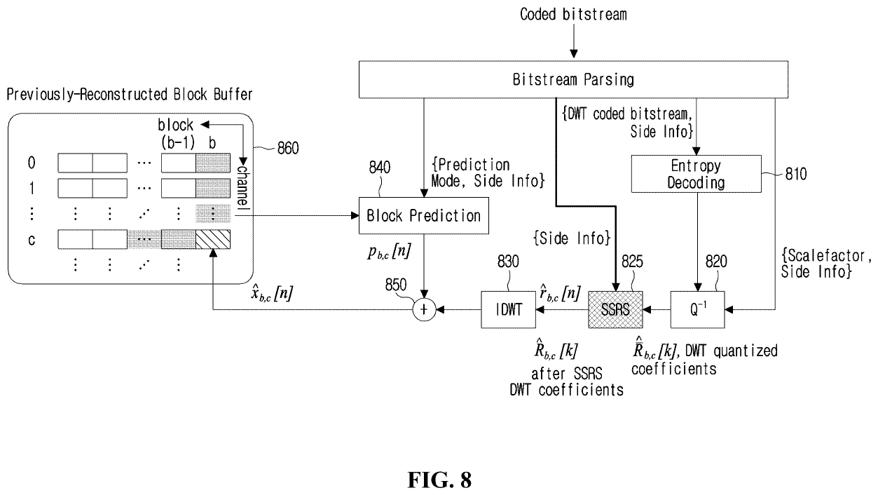

FIG. 8 is a diagram illustrating a one-dimensional waveform data decoding method and apparatus according to one embodiment of the present disclosure.

Referring to FIG. 8, the decoding apparatus according to the present disclosure may include an entropy decoding unit 810, an inverse quantization unit 820, a selective subblock inverse scaling unit 825, an inverse transform unit 830, a prediction unit 840, a reconstructed block generation unit 850, and a reconstructed block buffer 860.

The entropy decoding unit 810 may decode information related to intra prediction and inter prediction performed in the encoding apparatus. The entropy decoding unit 810 may decode the obtained index information by applying a selective subblock scaling method.

The quantized values are inverse quantized in the inverse quantization unit 820, and the selective subblock inverse scaling unit 825 may perform selective subblock inverse scaling on inverse quantized values. Specifically, index information obtained by applying selective subblock scaling-based encoding may be decoded to identify a subblock among one or more subblocks obtained from the inverse transformed coefficients, and inverse scaling may be performed by applying a scaling factor to the identified subblock. The selective subblock inverse scaling method has been described in detail with reference to FIG. 4, and a detailed description thereof will be omitted here.

The inverse transform unit 830 may perform an inverse transform that is, an inverse DCT, an inverse DST, or an inverse DWT, on coefficients on which selective subblock inverse scaling is performed. The inverse transform may be performed based on a transmission unit determined in the encoding apparatus. In the inverse transform unit 830 of the decoding apparatus, a transform technique (for example, DCT, DST, or DWT) may be selectively performed depending on various information such as a prediction method, a size of a current block, and a prediction direction.

The prediction unit 840 may generate a prediction block based on prediction block generation-related information provided from the entropy decoding unit 810 and previously decoded block or frame information from the reconstructed block buffer 860. As described in detail with reference to FIG. 2, a detailed description will be omitted here to avoid redundancy.

The reconstructed block generation unit 850 may generate a reconstructed block (x_{b,c}[n]) by adding the residual values (\hat{r}_{b,c}[n]) generated by the inverse quantization unit 820, the selective subblock inverse scaling unit 825, and the inverse transform unit 830 to the prediction unit (PU) (p_{b,c}[n]) predicted by the prediction unit 840.

The reconstructed block buffer 860 may store the reconstructed frames or blocks of a specific channel. Specifically, the index of a specific channel may be represented by c, where c may be an inter of 0, 1, 2, or more. The index of a frame or block may be represented by b, where b may be an integer of 0, 1, 2, or more.

The reconstructed block buffer 860 may store reconstructed frames or blocks so that they may be used as reference frames or reference blocks, and may also provide reconstructed frames to the output unit.

### Example 3

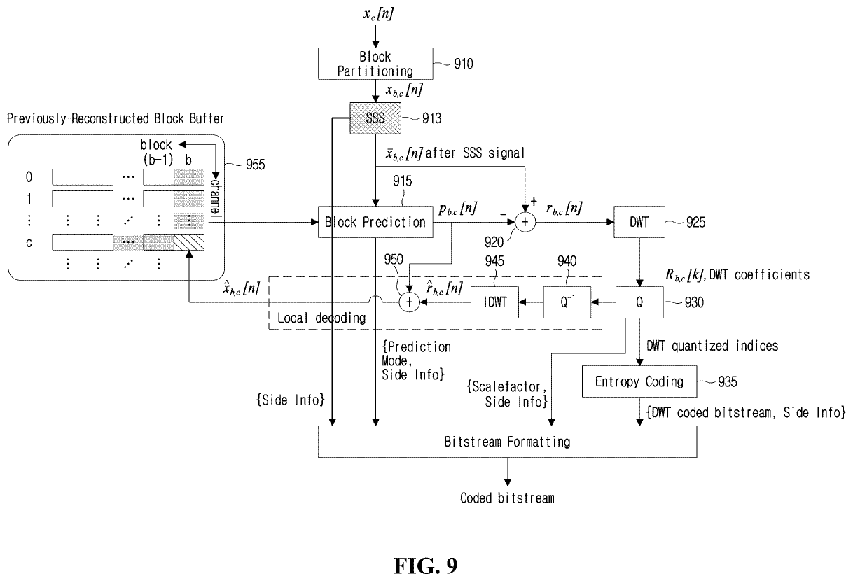

FIG. 9 is a diagram illustrating a one-dimensional waveform data encoding method and apparatus according to one embodiment of the present disclosure.

Referring to FIG. 9, the encoding apparatus according to the present disclosure may include at least one of a block partitioning unit 910, a selective subblock scaling unit 913, a prediction unit 915, a residual generation unit 920, a transform unit 925, a quantization unit 930, an entropy encoding unit 935, an inverse quantization unit 940, an inverse transform unit 945, a reconstructed block generation unit 950, and a reconstructed block buffer 955.

The block partitioning unit 910 may partition the input data into one or more processing units. That is, x_{c}[n] may be partitioned into x_{b,c}[n]. Additionally, one or more processing units may also be understood as original blocks or original signals. As described in detail with reference to FIG. 1, a detailed description will be omitted here to avoid redundancy.

The selective subblock scaling unit 913 may perform selective subblock scaling on an original block. Specifically, one or more subblocks of a predetermined size may be obtained from the original block on which a transform is performed. A predetermined indicator may be calculated for each of the one or more subblocks. Scaling may be performed by applying a scaling factor to the identified subblock. The selective subblock scaling method has been described in detail with reference to FIG. 3, and a detailed description thereof will be omitted here.

The original block (x_{b,c}[n]) on which selective subblock scaling is performed may be input to the prediction unit 915 and the residual generation unit 920.

The prediction unit 915 may include an inter prediction unit that performs inter-frame prediction and an intra prediction unit that performs intra-frame prediction.

The inter prediction unit may predict a prediction unit based on information from at least one of previous frames and subsequent frames of a current frame, and in some cases, may predict the prediction unit based on information from a portion of the encoded region within the current frame.

The intra prediction unit may generate a prediction unit based on reference sample information neighboring the current block, which is sample information within the current frame.

Additionally, the prediction mode information, motion vector information, etc. used for prediction may be encoded together with a residual value in the entropy encoding unit 935 and transmitted to the decoding apparatus. Regarding the prediction unit 915, as described in detail with reference to FIG. 1, a detailed description will be omitted here to avoid redundancy.

The residual generation unit 920 may generate a residual block (r_{b,c}[n]) that includes residual information, which is a difference between the prediction unit (PU) generated by the prediction unit 915 through prediction and the original block of the prediction unit (PU).

The transform unit 925 may transform the residual block including residual information of the original block and the prediction unit generated through the prediction unit 915 by selectively using one of a discrete cosine transform (DCT), discrete sine transform (DST), or discrete wavelet transform (DWT).

The quantization unit 930 may quantize the coefficients converted to the frequency domain by the transform unit 925.

The reordering unit may perform reordering of coefficient values for quantized residual values. The reordering unit may change two-dimensional block-form coefficients into a one-dimensional vector form through a coefficient scanning method. As described in detail with reference to FIG. 1, a detailed description will be omitted here.

The entropy encoding unit 935 may perform entropy encoding based on values generated by the reordering unit. The entropy encoding may use various encoding methods such as Exponential Golomb, Context-Adaptive Variable Length Coding (CAVLC), or Context-Adaptive Binary Arithmetic Coding (CABAC). The entropy encoding unit 935 may encode various information including residual coefficient information of a coding unit, block type information, prediction mode information, partitioning unit information, prediction unit information, transmission unit information, motion vector information, reference frame information, interpolation information of a block, quantization coefficient information, and filtering information. The entropy encoding unit 935 may encode the obtained index information by applying a selective subblock scaling method.

The inverse quantization unit 940 and the inverse transform unit 945 may inversely quantize the values (R_{b,c}[k]) quantized in the quantization unit 930 and inversely transform the coefficients transformed in the transform unit 925.

The reconstructed block generation unit 950 may generate a reconstructed block (\hat{x}_{b,c}[n]) by adding the residual values (\hat{r}_{b,c}[n]) generated by the inverse quantization unit 940 and the inverse transform unit 945 to the prediction unit (PU) (p_{b,c}[n]) predicted by the prediction unit 915.

The in-loop filter unit may include at least one of a deblocking filter, an offset compensation unit, and an adaptive loop filter (ALF). As described in detail with reference to FIG. 1, a detailed description will be omitted here.

The reconstructed block buffer 955 may store the reconstructed frames or blocks of a specific channel. Specifically, the index of a specific channel may be represented by c, where c may be an inter of 0, 1, 2, or more. The index of a frame or block may be represented by b, where b may be an integer of 0, 1, 2, or more.

The reconstructed block buffer 955 may store the generated reconstructed blocks or frames, and the stored reconstructed blocks or frames may be provided to the prediction unit 915 when performing inter prediction.

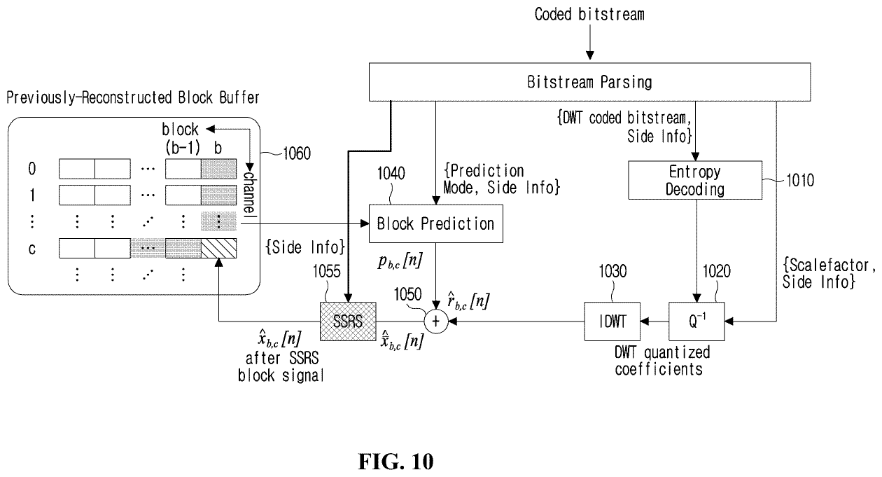

FIG. 10 is a diagram illustrating a one-dimensional waveform data decoding method and apparatus according to one embodiment of the present disclosure.

Referring to FIG. 10, the decoding apparatus according to the present disclosure may include an entropy decoding unit 1010, an inverse quantization unit 1020, an inverse transform unit 1030, a prediction unit 1040, a reconstructed block generation unit 1050, a selective subblock inverse scaling unit 1055, and a reconstructed block buffer 1060.

The entropy decoding unit 1010 may decode information related to intra prediction and inter prediction performed in the encoding apparatus. The entropy decoding unit 1010 may decode the obtained index information by applying a selective subblock scaling method.

The quantized values may be inverse quantized in the inverse quantization unit 1020. The inverse transform unit 1030 may perform an inverse transform that is, an inverse DCT, an inverse DST, or an inverse DWT. The inverse transform may be performed based on a transmission unit determined in the encoding apparatus. In the inverse transform unit 1030 of the decoding apparatus, a transform technique (for example, DCT, DST, or DWT) may be selectively performed depending on various information such as a prediction method, a size of a current block, and a prediction direction.

The prediction unit 1040 may generate a prediction block based on prediction block generation-related information provided from the entropy decoding unit 1010 and previously decoded block or frame information from the reconstructed block buffer 1060. As described in detail with reference to FIG. 2, a detailed description will be omitted here to avoid redundancy.

The reconstructed block generation unit 1050 may generate a first reconstructed block (\hat{\hat{x}}_{b,c}[n]) by adding the residual values (\hat{r}_{b,c}[n]) generated by the inverse quantization unit 1020 and the inverse transform unit 1030 to the prediction unit (PU) (p_{b,c}[n]) predicted by the prediction unit 1040.

The selective subblock inverse scaling unit 1055 may perform selective subblock inverse scaling on the first reconstructed block (\hat{\hat{x}}_{b,c}[n]) to generate a second reconstructed block. Specifically, index information obtained by applying selective subblock scaling-based encoding may be decoded to identify a subblock among one or more subblocks obtained from the first reconstructed block, and inverse scaling may be performed by applying a scaling factor to the identified subblock. The selective subblock inverse scaling method has been described in detail with reference to FIG. 4, and a detailed description thereof will be omitted here.

The reconstructed block buffer 1060 may store the reconstructed frames or blocks of a specific channel. Specifically, the index of a specific channel may be represented by c, where c may be an inter of 0, 1, 2, or more. The index of a frame or block may be represented by b, where b may be an integer of 0, 1, 2, or more.

The reconstructed block buffer 1060 may store reconstructed frames or blocks so that they may be used as reference frames or reference blocks, and may also provide reconstructed frames to the output unit.

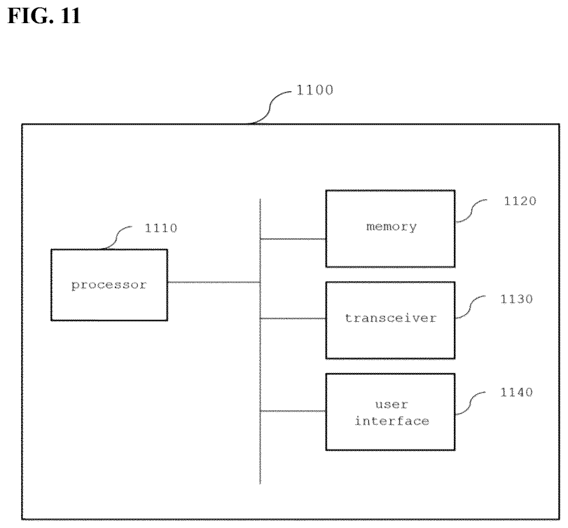

FIG. 11 is a block diagram illustrating an apparatus according to an embodiment of the present disclosure.

FIG. 11 is a block diagram illustrating a one-dimensional waveform data encoding apparatus or a one-dimensional waveform data decoding apparatus according to an embodiment of the present disclosure.

The apparatus 1100 may include one or more processors 1110, one or more memories 1120, one or more transceivers 1130, one or more user interfaces 1140, etc. The memory 1120 may be included in the processor 1110 or may be configured separately. The memory 1120 may store instructions that cause the apparatus 1100 to perform operations when executed by the processor 1110. The transceiver 1130 may transmit and/or receive signals, data, etc. that the apparatus 1100 exchanges with other entities. The user interface 1140 may receive an input of the user for the apparatus 1100 or provide an output of the apparatus 1100 to the user. Among the components of the apparatus 1100, components other than the processor 1110 and the memory 1120 may not be included in some cases, and other components not shown in FIG. 11 may be included in the apparatus 1100.

The processor 1110 may be configured to cause the apparatus 1100 to perform operations of the apparatus according to various examples of the present disclosure. Although not illustrated in FIG. 11, the processor 1110 may be configured as a set of modules each performing a function. The modules may be configured in the form of hardware and/or software.

The apparatus 1100 may perform encoding (or compression) of one-dimensional waveform data, and/or may perform decoding (or reconstruction) of one-dimensional waveform data.

For example, the encoding apparatus 1100 may generally support/perform the operation of generating a bitstream and the operation of transmitting a bitstream.

Specifically, the processor 1110 of the encoding apparatus 1100 is configured to obtain one or more subblocks having a predetermined size, calculate a predetermined indicator for each of the one or more subblocks, identify a subblock among one or more subblocks based on the calculated predetermined indicator and encode the index information of the identified subblock, and perform scaling by applying a scaling factor to the identified subblock, wherein the identified subblock is determined based on having the largest value of a predetermined indicator among the one or more subblocks. In this regard, detailed descriptions are omitted herein to avoid redundancy, since the details have been described with reference to FIG. 3.

For example, the decoding apparatus 1100 may generally support/perform the operation of obtaining a bitstream and the operation of reconstructing one-dimensional waveform data.

For example, the processor 1110 of the decoding apparatus 1100 is configured to decode index information obtained by applying selective subblock scaling-based encoding to identify a subblock among one or more subblocks, perform inverse scaling by applying a scaling factor to the identified subblock, and reconstruct a current block based on a result of the inverse scaling, wherein the identified subblock is determined based on having the largest value of a predetermined indicator among the one or more subblocks. In this regard, detailed descriptions are omitted herein to avoid redundancy, since the details have been described with reference to FIG. 4.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for decoding one-dimensional waveform data, the method comprises: decoding index information obtained by applying selective subblock scaling-based encoding to identify a subblock among one or more subblocks;
performing inverse scaling by applying a scaling factor to the identified subblock; and
reconstructing a current block based on a result of the inverse scaling,
wherein the identified subblock is determined based on having the largest value of a predetermined indicator among the one or more subblocks.

2. The method of claim 1, wherein the inverse scaling is performed on the subblock identified among one or more subblocks,
wherein the one or more subblocks are obtained from a residual block for the current block.

3. The method of claim 1, wherein the inverse scaling is performed on the subblock identified among one or more subblocks,
wherein the one or more subblocks are obtained from inverse-quantized transform coefficients for the current block.

4. The method of claim 1, wherein the inverse scaling is performed on the subblock identified among one or more subblocks,
wherein the one or more subblocks are obtained from a first reconstructed block, and
wherein the first reconstructed block is generated based on a prediction block of the current block and a residual block for the current block.

5. The method of claim 1, wherein the predetermined indicator is calculated based on either a signal-independent method or a signal-dependent method,
wherein the signal-independent method includes at least one of an L2-norm, an L1-norm, and an Lp-norm, and
wherein the signal-dependent method includes at least one of a PRD, CPRD, PSNR, and a RD-loss.

6. The method of claim 1, wherein the scaling factor is determined as a pre-defined value identically in an encoding apparatus and a decoding apparatus.

7. The method of claim 1, wherein the scaling factor is determined as a factor among a plurality of scaling factors, and
wherein index information for specifying the factor is signaled.

8. The method of claim 1, wherein the scaling factor is determined based on at least one of characteristics of data for which scaling is performed and a signal availability range.

9. The method of claim 1, wherein whether to perform the inverse scaling on the identified subblock is determined based on flag information indicating whether to perform the inverse scaling, and
wherein the flag information is signaled for one of a block level or a file level.

10. An apparatus for decoding one-dimensional waveform data, the apparatus comprises:
one or more transceivers;
one or more memories; and
one or more processors, the one or more processors being configured to:
decode index information obtained by applying selective subblock scaling-based encoding to identify a subblock among one or more subblocks,
perform inverse scaling by applying a scaling factor to the identified subblock, and
reconstruct a current block based on a result of the inverse scaling,
wherein the identified subblock is determined based on having the largest value of a predetermined indicator among the one or more subblocks.

11. A method for encoding one-dimensional waveform data, the method comprises:
obtaining one or more subblocks having a predetermined size;
calculating a predetermined indicator for each of the one or more subblocks;
identifying a subblock among one or more subblocks based on the calculated predetermined indicator and encoding index information of the identified subblock; and
performing scaling by applying a scaling factor to the identified subblock,
wherein the identified subblock is determined based on having the largest value of a predetermined indicator among the one or more subblocks.

12. The method of claim 11, wherein the scaling is performed on the subblock identified among one or more subblocks, and
wherein the one or more subblocks are obtained from a residual block for a current block.

13. The method of claim 11, wherein the scaling is performed on the subblock identified among one or more subblocks, and
wherein the one or more subblocks are obtained from transform coefficients for a current block.

14. The method of claim 11, wherein the scaling is performed on the subblock identified among one or more subblocks, and
wherein the one or more subblocks are obtained from a current block.

15. The method of claim 11, wherein the predetermined indicator is calculated based on either a signal-independent method or a signal-dependent method,
wherein the signal-independent method includes at least one of an L2-norm, an L1-norm, and an Lp-norm, and
wherein the signal-dependent method includes at least one of a PRD, CPRD, PSNR, and a RD-loss.

16. The method of claim 11, wherein the scaling factor is determined as a pre-defined value identically in an encoding apparatus and a decoding apparatus.

17. The method of claim 11, wherein the scaling factor is determined as a factor among a plurality of scaling factors, and
wherein index information for specifying the factor is signaled.

18. The method of claim 11, wherein the scaling factor is determined based on at least one of characteristics of data for which scaling is performed and a signal availability range.

19. The method of claim 11, wherein whether to perform the scaling on the identified subblock is determined based on flag information indicating whether to perform the scaling, and
wherein the flag information is signaled for one of a block level or a file level.

20. An apparatus for encoding one-dimensional waveform data, the apparatus comprises:
one or more transceivers;
one or more memories; and
one or more processors, the one or more processors being configured to:
obtain one or more subblocks having a predetermined size;
calculate a predetermined indicator for each of the one or more subblocks,
identify a subblock among one or more subblocks based on the calculated predetermined indicator and encode index information of the identified information of the identified subblock, and
perform scaling by applying a scaling factor to the identified subblock,
wherein the identified subblock is determined based on having the largest value of a predetermined indicator among the one or more subblocks.
